(19) United States
(12) Patent Application Publication
(10) Pub. No.: US 2025/0260773 A1
(43) Pub. Date: Aug. 14, 2025

(54) IMAGE PROCESSING APPARATUS, IMAGE PROCESSING METHOD, AND MEDIUM STORING PROGRAM

(71) Applicant: CANON KABUSHIKI KAISHA, Tokyo (JP)

(72) Inventor: KIICHI HASEGAWA, Kanagawa (JP)

(21) Appl. No.: 19/044,951

(22) Filed: Feb. 4, 2025

(30) Foreign Application Priority Data
Feb. 8, 2024 (JP) 2024-017771

(51) Int. Cl. H04N 1/00; H04L 51/046

(52) U.S. Cl. CPC H04N 1/00477; H04L 51/046

(57) ABSTRACT

An image processing apparatus includes a modem that receives image data via facsimile (FAX), one or more memories storing one or more programs and one or more processors executing the program to cause the image processing apparatus to acquire status information indicating a state of a user from a chat service, and a printer that prints an image based on the received image data on a recording medium, wherein the processor causes the image processing apparatus to acquire the status information about a user corresponding to sender information about the received image data, and wherein the printer, based on acquisition of specific status information, prints the image based on the received image data on the recording medium without the image processing apparatus accepting the user's print instruction after the acquisition of the status information.

### BACKGROUND

### Field

The present disclosure relates to an image processing apparatus, an image processing method, and a medium storing a program.

### Description of the Related Art

There is a technique where an image processing apparatus transmits received images to a cloud server that provides a cloud storage service or a chat service. Japanese Patent Application Laid-Open No. 2023-15663 discusses a technique that enables a setting as to whether to simply print a document received via facsimile (FAX) or store the document in a “FAX reception box” without printing.

Images based on image data received via FAX are desirably printed in a situation where the intended user to receive the printout can immediately receive the printout.

In the case of an image processing apparatus discussed in Japanese Patent Application Laid-Open No. 2023-15663, the setting whether to print a document received by the image processing apparatus via FAX is desirably switched by the user operating the operation unit of the image processing apparatus. For example, if the user frequently alternates between working in the office and working from home and wants printouts to be printed only when the user is working in the office (situation where the user is likely to be able to receive the printouts), the setting is desirably changed each time, which is troublesome.

### SUMMARY

The present disclosure is directed to reducing the effort for an image processing apparatus to print images based on image data received via facsimile (FAX) if there are situations where the user is likely to be able to immediately receive the printout and situations where they are not.

According to an aspect of the present disclosure, an image processing apparatus includes a modem configured to receive image data via facsimile (FAX), one or more memories storing one or more programs and one or more processors executing the program to cause the image processing apparatus to acquire status information indicating a state of a user from a chat service, and a printer configured to print an image based on the received image data on a recording medium, wherein the processor causes the image processing apparatus to acquire the status information about a user corresponding to sender information about the received image data, and wherein the printer is configured to, based on acquisition of specific status information, print the image based on the received image data on the recording medium without the image processing apparatus accepting the user's print instruction after the acquisition of the status information.

Further features of the present disclosure will become apparent from the following description of exemplary embodiments with reference to the attached drawings.

### BRIEF DESCRIPTION OF THE DRAWINGS

FIG. 1 is a diagram illustrating an example of an overall configuration of a message application service.

FIG. 2 is a diagram illustrating an example of a hardware configuration of a multifunction peripheral (MFP).

FIG. 3 is a diagram illustrating an example of a hardware configuration of a user terminal.

FIG. 4 is a diagram illustrating an example of a hardware configuration of a message application server.

FIG. 5 is a diagram illustrating an example of a hardware configuration of a tenant server.

FIG. 6 is a diagram illustrating an example of tenant information.

FIG. 7 is a diagram illustrating an example of a status table.

FIG. 8 is a diagram illustrating an example of a status table setting screen for setting the status table.

FIG. 9 is a diagram illustrating an example of a recipient user table.

FIG. 10 is a diagram illustrating an example of screens for setting the recipient user table.

FIG. 11 is a diagram illustrating an example of a sequence for setting the recipient user table.

FIG. 12 is a flowchart illustrating an example of setting processing of the recipient user table.

FIG. 13 is a diagram illustrating an example of a sequence in spooling a facsimile (FAX) job based on the status table.

FIG. 14 is a diagram illustrating an example of a sequence in printing images based on spooled image data depending on a change in status.

FIG. 15 is a diagram illustrating an example of a chat screen of a message application.

FIG. 16 is a flowchart illustrating an example of processing of a FAX job received by the MFP.

### DESCRIPTION OF THE EMBODIMENTS

Exemplary embodiments of the present disclosure will be described in detail below with reference to the drawings. The following exemplary embodiments are not intended to limit the scope of the claims, and all combinations of features described in the exemplary embodiments are not necessarily essential to the present disclosure.

In an exemplary embodiment of the present disclosure, a multifunction peripheral (MFP) having a print, scan, and facsimile (FAX) functions will be described as an example of an image processing apparatus. The image processing apparatus according to the present exemplary embodiment is not limited to an MFP, and may be any apparatus that can implement the present exemplary embodiment. Examples include an apparatus without a scan function, and an apparatus that transmits print instructions to an image forming apparatus including a printing unit.

The present exemplary embodiment will be described using FAX reception jobs as an example. However, the present disclosure is not limited thereto, and can be applied to print jobs other than FAX reception jobs.

The exemplary embodiment of the present disclosure will now be described.

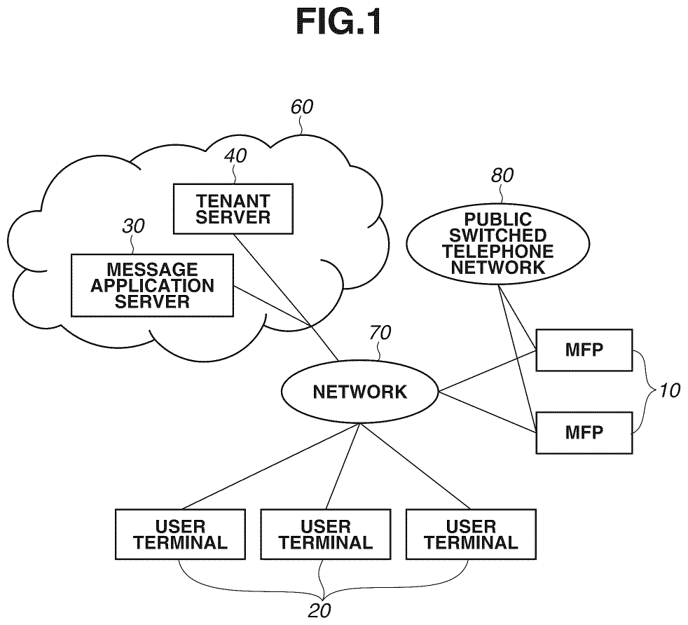

FIG. 1 is a diagram illustrating an example of an overall configuration of a message application service. The message application service is an example of a cloud service, and also a chat service. The cloud service according to the present exemplary embodiment is not limited to a message application service, and may be, for example, a mail, storage, or information management service in the cloud.

The message application service includes, for example, MFPs 10 that are image processing apparatuses, user terminals 20, a message application server 30, and a tenant server 40. The MFPs 10, the user terminals 20, and the servers 30 and 40 are connected via a network 70 and can communicate with each other. The network 70 is a wireless or wired network including the Internet, a wide area network (WAN), and/or a local area network (LAN). The MFPs 10 are connected to a public switched telephone network (PSTN) 80 and can control FAX communication protocols.

The MFPs 10 have a function of receiving image data, and have the capability to print images based on the image data on recording media. For example, the MFPs 10 can receive image data from the network 70, such as the Internet, and the PSTN 80. The MFPs 10 according to the present exemplary embodiment refer to image processing apparatuses that also have a function of communicating with the message application server 30 via the network 70 and transmitting and receiving image data. The MFPs 10 can thus receive image data from the message application server 30 and print images based on the received image data. The MFPs 10 can read documents and generate image data based on the read document images, and transmit the image data generated based on the read document images to the message application server 30. What the MFPs 10 transmit and receive is not limited to image data. For example, the MFPs 10 can transmit and receive various types of data and signals, such as signals used in controlling FAX communication protocols. While FIG. 1 illustrates an example where two MFPs 10 are connected, any number of MFPs 10 may be connected.

The user terminals 20 are examples of information terminals that users use to use the message application service. Examples include smartphones, tablet terminals, and personal computers. While FIG. 1 illustrates an example where three user terminals 20 are connected, any number of user terminals 20 may be connected. The users operate the user terminals 20 to access the message application server 30 in a cloud 60, exchange messages with other users, and use installed applications. The user terminals 20 and the message application server 30 are connected to the wired or wireless communication network (network 70) and can transmit and receive data to/from each other. In the present exemplary embodiment, the Internet is assumed as an example of the communication network 70. However, dedicated lines may be used.

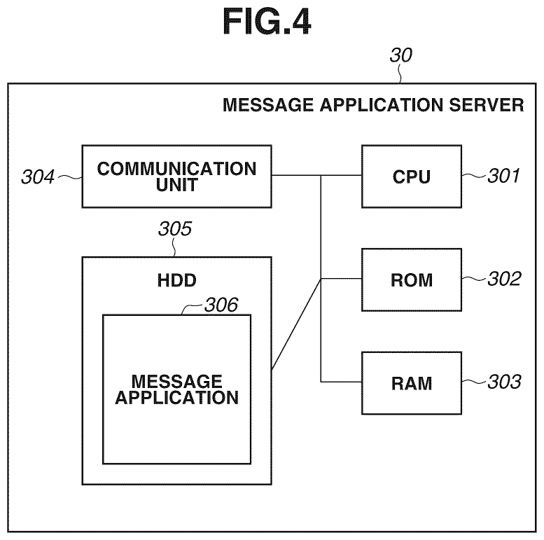

The message application server 30 is a cloud server deployed in the cloud 60 and is a server that provides a service using a message application 306 (see FIG. 4). The message application server 30 performs processing related to message exchange in general, such as message transmission and reception processing with the user terminals 20 and display of message transmission and reception screens.

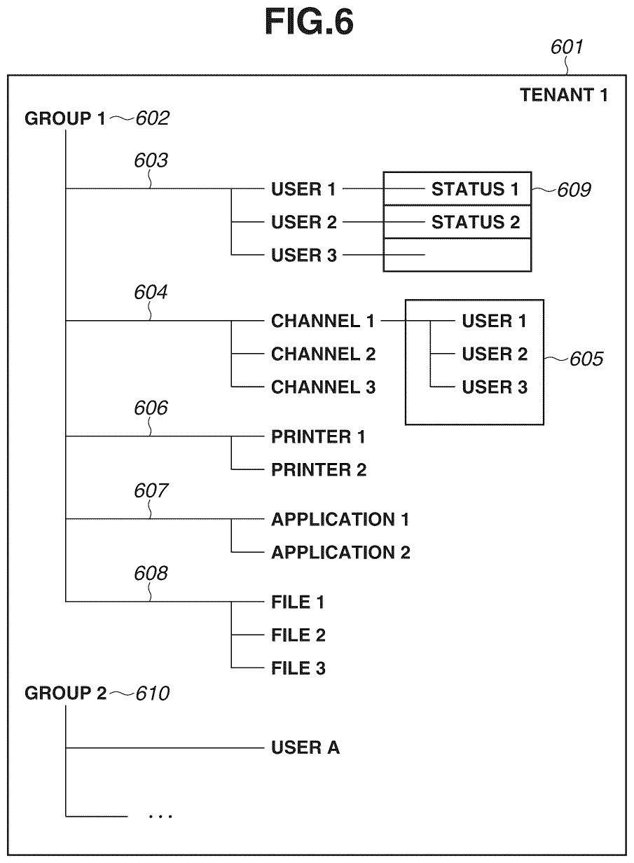

The tenant server 40 is a cloud server deployed in the cloud 60 and is a server that stores and provides pieces of tenant information. Details of the tenant information stored in the tenant server 40 will be described below with respect to FIG. 6.

Part or all of the capabilities of the tenant server 40 described below and the processing performed by the tenant server 40 may be substituted by the message application server 30. In such a case, the tenant server 40 is not required in the present configuration.

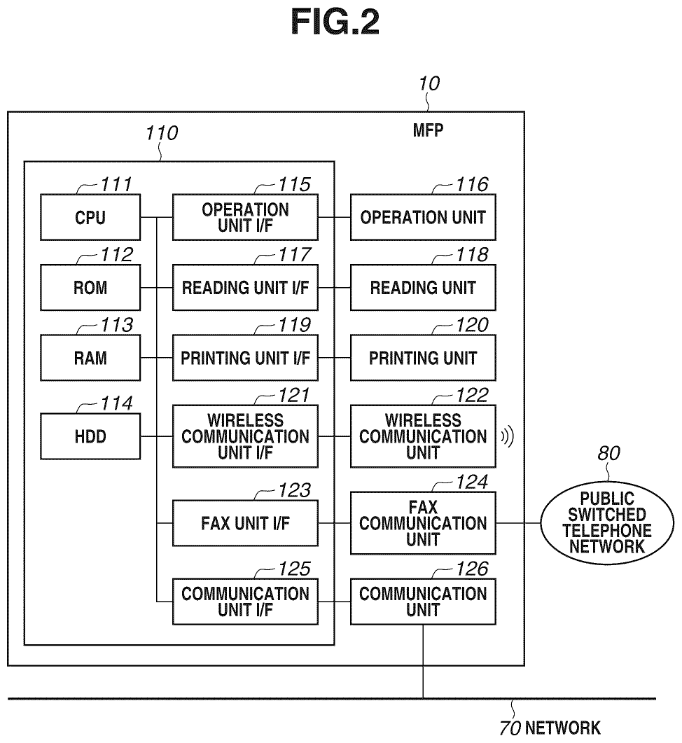

FIG. 2 is a diagram illustrating an example of a hardware configuration of an MFP 10. The MFP 10 includes a control unit 110, an operation unit 116, a reading unit 118, a printing unit 120, a wireless communication unit 122, a FAX communication unit 124, and a communication unit 126. The control unit 110 includes a central processing unit (CPU) 111, a read-only memory (ROM) 112, a random access memory (RAM) 113, a hard disk drive (HDD) 114, and various interfaces (I/Fs).

The various I/Fs include an operation unit I/F 115, a reading unit I/F 117, a printing unit I/F 119, a wireless communication unit I/F 121, a FAX unit I/F 123, and a communication unit I/F 125.

The operation unit I/F 115 is a connection unit between the control unit 110 and the operation unit 116, and connects the control unit 110 and the operation unit 116. The reading unit I/F 117 is a connection unit between the control unit 110 and the reading unit 118, and connects the control unit 110 and the reading unit 118. The printing unit I/F 119 is a connection unit between the control unit 110 and the printing unit 120, and connects the control unit 110 and the printing unit 120. The wireless communication unit I/F 121 is a connection unit between the control unit 110 and the wireless communication unit 122, and connects the control unit 110 and the wireless communication unit 122. The FAX unit I/F 123 is a connection unit between the control unit 110 and the FAX communication unit 124, and connects the control unit 110 and the FAX communication unit 124. The communication unit I/F 125 is a connection unit between the control unit 110 and the communication unit 126, and connects the control unit 110 and the communication unit 126.

The control unit 110 including the CPU 111 controls operation of the entire MFP 10. The CPU 111 reads control programs stored in the ROM 112 or the HDD 114 into the RAM 113, and performs various types of control including a read control and a print control. The ROM 112 stores control programs executable by the CPU 111. The ROM 112 also stores a boot program and font data. The RAM 113 is a main storage memory of the CPU 111, and is used as a work area and a temporary storage area for loading various control programs stored in the ROM 112 and the HDD 114. The HDD 114 stores image data, print data, various programs, various addresses, and various types of setting information, for example. The HDD 114 is a storage medium, which is not limited to the HDD 114 and may be a flash memory, a solid-state drive (SSD), or an embedded MultiMediaCard (eMMC).

The MFP 10 according to the present exemplary embodiment is configured so that the single CPU 111 performs processes illustrated in flowcharts to be described below, using the single memory (RAM 113). However, this is not restrictive. For example, a plurality of CPUs, RAMs, ROMs, and HDDs can cooperate to perform the processes. Hardware circuits such as an application-specific integrated circuit (ASIC) and a field-programmable gate array (FPGA) may be used to perform some of the processes.

The operation unit 116 includes a display unit such as a touchscreen, and hardware keys, for example. The operation unit 116 displays information to the user and accepts input from the user. Examples of the input from the user include input of instructions for causing the MFP 10 to perform desired processing, input of characters and symbols to the MFP 10, and operation inputs for the user to browse information. Examples of the input of instructions for causing the MFP 10 to perform desired processing include inputting instructions to perform processes executable by the MFP 10, such as print instructions. Examples of the operation inputs for the user to browse information include inputs for selecting a file or changing a display size to browse data stored in the HDD 114. The touchscreen may use any typical input method or detection method such as resistive, infrared, electromagnetic induction, and capacitive methods. Examples of the hardware keys may include a keyboard including keys labeled with alphabets and numerals, and physical buttons for instructing processing like a “start” key and a “reset” key. Toggle switches, rocker switches, push-button switches, rotary switches, slide switches, key lock switches, and/or tactile switches may also be used, for example.

Examples of the reading unit 118 include a scanner. The reading unit 118 reads a document by moving the document or a sensor, and generates image data such as binary data based on the read document image. The image data generated by the reading unit 118 is transmitted to an external apparatus such as an information processing apparatus, stored in an external recording device such as a Universal Serial Bus (USB) device, or printed on recording sheets, for example.

The printing unit 120 receives image data to be printed (target image data to be printed) from the CPU 111, and prints the images on recording sheets fed from a feed cassette (not illustrated). The operation of the printing unit 120 is not limited to printing on sheets of paper, and may be performed on non-paper media such as overhead projector (OHP) sheets.

The wireless communication unit 122 wirelessly connects the control unit 110 with external wireless devices. The user terminals 20 are examples of the wireless devices connected to the MFP 10.

The FAX communication unit 124 includes a modem and a network control unit (NCU) for FAX communication, for example. The FAX communication unit 124 connects to the PSTN 80 and controls FAX communication protocols by controlling the modem and NCU.

The communication unit 126 transmits image data and various types of information in the MFP 10 to external apparatuses connected to the network 70, and receives print data and various types of information from information processing apparatuses connected to the network 70. Examples of the various types of information include status information and setting information. The transmission and reception via the network 70 can be implemented, for example, by electronic mail (email) transmission and reception, or file transmission and reception using other protocols (such as the File Transfer Protocol [FTP], Server Message Block [SMB], and Web Distributed Authoring and Versioning [WebDAV]). The communication unit 126 can also transmit and receive image data and message data over the network 70 in response to access from the user terminals 20 and the message application server 30 using Hypertext Transfer Protocol [HTTP] communication. The users can access the MFP 10 from the web browsers on the user terminals 20 via the network 70 and configure various settings of the MFP 10 (remote user interface [UI] function).

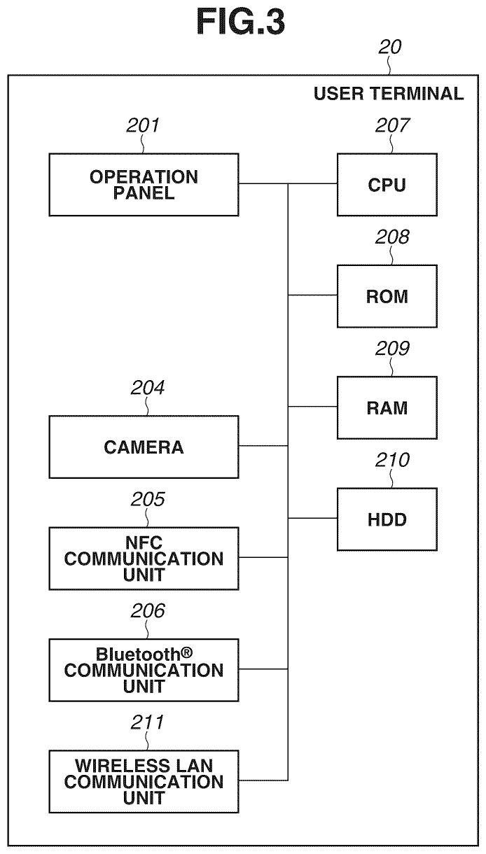

FIG. 3 is a diagram illustrating an example of a hardware configuration of a user terminal 20. While the user terminals 20 according to the present exemplary embodiment are assumed to be devices such as smartphones and tablet personal computers (PCs), the user terminals 20 are not limited thereto. For example, any other information processing apparatus that can connect to the network 70 through a wired connection using the Ethernet® or a wireless connection using radio waves, such as Wireless Fidelity (Wi-Fi®) communication, can be used. The wireless connection method is not limited to Wi-Fi® communication. For example, Bluetooth® and other communication methods may be used.

The user terminal 20 includes an operation panel 201, a camera 204, a near-field communication (NFC) communication unit 205, a Bluetooth® communication unit 206, a CPU 207, a ROM 208, a RAM 209, an HDD 210, and a wireless LAN communication unit 211.

The CPU 207 reads control programs stored in the ROM 208 or the HDD 210 and performs various types of processing for controlling operation of the user terminal 20. The ROM 208 stores control programs executable by the CPU 207. The RAM 209 is a main storage memory of the CPU 207, and is used as a work area and a temporary storage area for loading various control programs stored in the ROM 208 and the HDD 210.

The HDD 210 stores, for example, image data, print data, various programs, various application programs, various addresses, and various types of setting information. The HDD 210 is a storage medium, which is not limited to an HDD and may be a flash memory, an SSD, or an eMMC.

The user terminal 20 according to the present exemplary embodiment is configured so that the single CPU 207 performs processes illustrated in the flowcharts to be described below using the single memory (RAM 209). However, this is not restrictive. For example, a plurality of CPUs, RAMs, ROMs, and HDDs can cooperate to perform the processes. Hardware circuits such as an ASIC and an FPGA may be used to perform some of the processes. The operation panel 201 has a touchscreen function capable of detecting the user's touch operations, and displays various screens provided by an operating system (OS) and applications. The operation panel 201 is also used to check information stored in the message application server 30. The user can input desired operation instructions to the user terminal 20 by inputting touch operations to the operation panel 201. The user terminal 20 includes not-illustrated hardware keys, and the user can input operation instructions to the user terminal 20 using the hardware keys. The detection method for detecting the user's touch operations on the touchscreen may be any typical detection method such as resistive, infrared, electromagnetic induction, and capacitive methods. Software keys may be displayed on the touchscreen so that operation instructions are input by user operation on the touchscreen. Any OS may be used as the OS. Examples include Windows, macOS, Unix, Linux, Android, and iOS. Examples of the applications may include applications for performing email transmission, browsing, chat, camera imaging, image display, and setting configuration functions.

The camera 204 captures images based on the user's imaging instructions. The images captured by the camera 204 are stored in a predetermined area of the HDD 210. A program capable of analyzing Quick Response (QR) codes may be stored in the ROM 208 or the HDD 210 in advance, or an application with that function may be installed, so that information can be acquired from QR codes® read by the camera 204. The information acquisition is not limited to QR codes®. For example, one-dimensional codes such as barcodes, or two-dimensional codes such as DataMatrix, MaxiCode, Portable Data File 417 (PDF417), and Aztec codes may be analyzed for information acquisition.

The user terminal 20 can connect to various wireless devices via the NFC communication unit 205, the Bluetooth® communication unit 206, and the wireless LAN communication unit 211, and transmit and receive data. The Bluetooth® communication unit 206 of the user terminal 20 may support the Bluetooth® Low Energy standard and/or the Bluetooth® Classic standard.

While the user terminal 20 according to the present exemplary embodiment establishes wireless network connections, a not-illustrated wired port may be disposed to establish a wired network connection, for example.

FIG. 4 is a diagram illustrating an example of a hardware configuration of the message application server 30. The message application server 30 refers to a chat server that provides a chat service.

The message application server 30 mainly includes a CPU 301, a ROM 302, a RAM 303, a communication unit 304, and an HDD 305.

The CPU 301 reads control programs stored in the ROM 302 and the message application 306 stored in the HDD 305, loads the programs into the RAM 303, and performs various types of processing for controlling operation of the message application server 30. The ROM 302 stores the control programs executable by the CPU 301. The RAM 303 is a main storage memory of the CPU 301, and is used as a work area and a temporary storage area for loading various control programs stored in the ROM 302 and the HDD 305.

The HDD 305 stores various types of data such as messages, image data, channel information, and application programs. The HDD 305 is a storage medium, which is not limited to an HDD and may be a flash memory, an SSD, or an eMMC.

The message application server 30 according to the present exemplary embodiment is configured so that the single CPU 301 performs processes illustrated in the flowcharts to be described below, using the single memory (RAM 303). However, this is not restrictive. For example, a plurality of CPUs, RAMs, ROMs, and HDDs can cooperate to perform the processes. Hardware circuits such as an ASIC and an FPGA may be used to perform some of the processes.

The message application 306 is an application installed on the HDD 305, and runs on the CPU 301 or the RAM 303.

The communication unit 304 is used to communicate with other devices. For example, data can be transmitted and received to/from various devices, such as the user terminals 20 and the MFPs 10, via the communication unit 304. The communication unit 304 may perform wired communication using the Ethernet, or wireless communication such as Wi-Fi® communication. An operation example of the message application server 30 when a message is posted using a user terminal 20 will be described. The CPU 301 loads the message application 306 read from the HDD 305 into the RAM 303, and receives the posted message transmitted from the user terminal 20 via the communication unit 304 under the control of the message application 306. The CPU 301 then stores the posted message received from the user terminal 20 in the HDD 305. The CPU 301 can notify the user terminal 20 or other user terminals 20 of the posting of the message over the network 70 via the communication unit 304 as appropriate. The notified user terminal(s) 20 display(s) the notification on its/their operation panel 201 of touchscreen form.

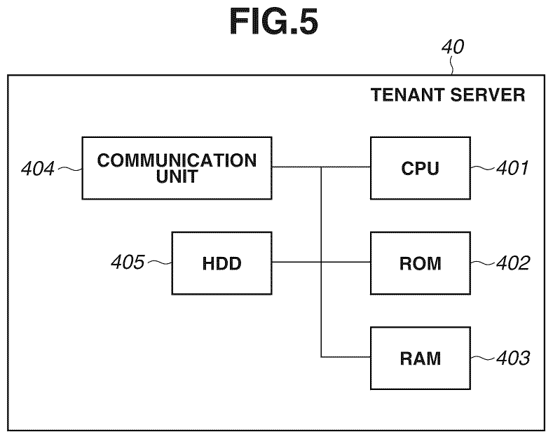

FIG. 5 is a diagram illustrating an example of a hardware configuration of the tenant server 40.

The tenant server 40 includes a CPU 401, a ROM 402, a RAM 403, a communication unit 404, and an HDD 405.

The CPU 401 reads control programs stored in the ROM 402 or the HDD 405 and performs various types of processing for controlling tenant information 601. The tenant information 601 to be stored will be described below. The ROM 402 stores control programs executable by the CPU 401. The RAM 403 is a main storage memory of the CPU 401, and is used as a work area and a temporary storage area for loading various control programs stored in the ROM 402 and HDD 405.

The HDD 405 stores the tenant information 601, for example. The HDD 405 is a storage medium, which is not limited to an HDD and may be a flash memory, an SSD, or an eMMC.

The tenant server 40 according to the present exemplary embodiment is configured so that the single CPU 401 performs various processes illustrated in the flowcharts to be described below using the single memory (RAM 403). However, this is not restrictive. For example, a plurality of CPUs, RAMs, ROMs, and HDDs can cooperate to perform the processes. Hardware circuits such as an ASIC and an FPGA may be used to perform some of the processes.

The communication unit 404 is used to communicate with other devices. Data can be transmitted and received to/from various devices, such as the message application server 30, via the communication unit 404. The communication unit 404 may perform wired communication using the Ethernet, or wireless communication such as Wi-Fi® communication.

An operation example of the tenant server 40 when the tenant server 40 transmits the tenant information 601 to an MFP 10 will now be described. The CPU 401 initially receives an acquisition request for specific information in the tenant information 601 from the MFP 10 via the communication unit 404 and the network 70. As described herein, the specific information refers to any of the pieces of various types of information managed by the tenant server 40 in the tenant information 601 to be described below, such as group information, user information, and channel information, and varies depending on user instructions. The CPU 401 accesses the tenant information 601 stored in the HDD 405 using a control program loaded from the ROM 402 into the RAM 403, and acquires the requested specific information. Once the acquisition of the specific information is completed, the CPU 401 transmits the specific information to the MFP 10 from which the acquisition request for the specific information is transmitted, via the communication unit 404 and the network 70.

As described above, part or all of the capabilities of the tenant server 40 and the processing performed by the tenant server 40 may be substituted by the message application server 30.

FIG. 6 is a diagram illustrating an example of the tenant information 601. In the present exemplary embodiment, the tenant information 601 is, for example, stored in the HDD 405 of the tenant server 40.

The tenant information 601 includes one or more groups. In the example of FIG. 6, the tenant information 601 includes two groups, namely, group 1 and group 2, whereby group information 602 and group information 610 are managed.

Depending on the configuration of the message application 306, there may be cases where a piece of tenant information includes only one piece of group information. In such a case, the tenant information 601 and the group information are the same.

The group information 602 and the group information 610 each include pieces of information that constitute the group. For example, the group information 602 includes user information 603, channel information 604, printer information 606, associated application information 60, and file information 608.

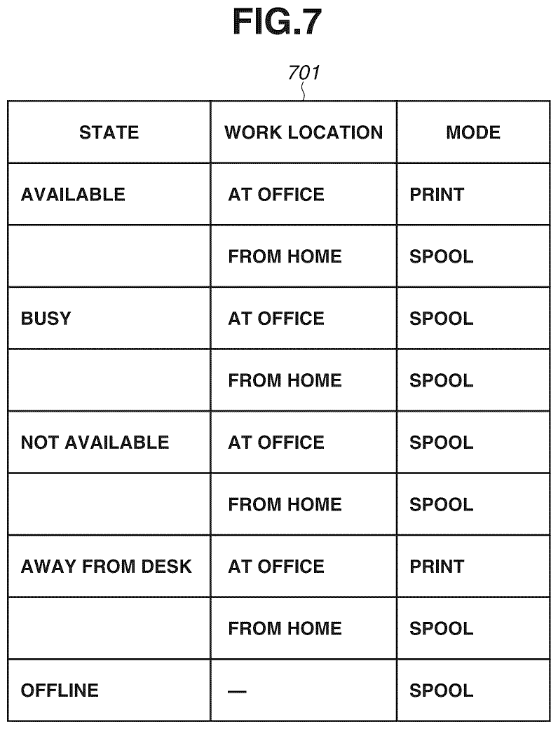

The user information 603 includes information about each user belonging to the group. For example, the user information 603 includes identifiers (IDs) specific to the respective users. The user information 603 also includes respective pieces of status information 609. The status information 609 is an information set indicating what states the users are currently in, including attendance statuses indicating whether the users are at the office or working from home, and situation statuses indicating the current situations of the users. Examples of the attendance statuses include “at office”, “from home”, and “out”. Examples of the situation statuses include “available” and “away from desk”. In addition to the examples illustrated in FIG. 7, various states such as “active” and “away” can be managed. The status information 609 is not limited to the attendance statuses or the situation statuses. Various statuses can be used depending on the service that manages and provides the statuses.

The channel information 604 is information for grouping the pieces of user information 603, and includes a list 605 where the pieces of user information about the users belonging to each channel are summarized. For example, the channel information 604 includes IDs specific to respective channels.

The printer information 606 indicates machine information about the MFPs 10. Examples of the machine information about the MFPs 10 include manufacturer information, model number, serial number, media access control (MAC) address, and Internet Protocol (IP) address. Applications using the group information 602 can transmit various commands to a given MFP 10 by referring to or acquiring the group information 602.

The associated application information 607 is information about applications associated with the message application 306 corresponding to group 1. Examples of the applications associated with the message application 306 include various Microsoft® Office applications (software).

The file information 608 is information about files stored and shared within the group. For example, when an MFP 10 prints, the file information 608 is transmitted to the MFP 10.

In the present exemplary embodiment, a place where chat messages exchanged between individual users are displayed and that is not managed as a channel will be referred to as a talk room. Channels may have functions such as a schedule sharing function, aside from a chat displaying function. Such names are not limited thereto, and channels and talk rooms may be set with different names depending on the provider of the service.

To acquire the user list of, e.g., group 1, the message application 306 acquires the list of the user information 603 in the group information 602, stored in the HDD 405 of the tenant server 40, via the communication unit 304 and the network 70. The message application 306 also acquires and uses the channel information 604, the printer information 606, the associated application information 607, the file information 608, and the status information 609 as appropriate in a similar manner.

FIG. 7 is a diagram illustrating an example of a status table 701. In the present exemplary embodiment, the status table 701 is, for example, stored in the HDD 114 of each MFP 10.

The status table 701 includes parameters corresponding to the status information 609 retained in the tenant server 40. In the present exemplary embodiment, as examples of the parameters, the foregoing situation statuses are stored in a “state” column of the status table 701, the attendance statuses in a “work location” column, and operation modes of the MFP 10 when the respective statuses are acquired in a “mode” column. For example, when the state status is “available” and the working location status is “at office”, the operation mode stored in the status table 701 of FIG. 7 is “print”. As will be described below, the MFP 10 performs the operations corresponding to the operation modes based on the status table 701.

As described herein, the operation mode “print” refers to a mode where the MFP 10 prints upon FAX reception without spooling. The operation mode “spool” refers to processing where the MFP 10, when receiving information including image data, does not print immediately but stores the received information including the image data in the RAM 113 or the HDD 114 of the MFP 10, or a nonvolatile area such as a cloud storage, for example. The HDD 114 and the cloud storage are examples of a storage device. The spool processing is an example of storage processing. Images based on the image data spooled by the MFP 10 are printed in response to the user's print instructions. Operation examples in these modes will be described below.

The status table 701 may be stored in the MFP 10 (for example, in the HDD 114) or in an external device that can communicate with the MFP 10. In the present exemplary embodiment, the status table 701 is configured so that the user can freely specify operation modes via the operation unit 116 of the MFP 10. However, this is not restrictive, and the status table 701 may be an unmodifiable one.

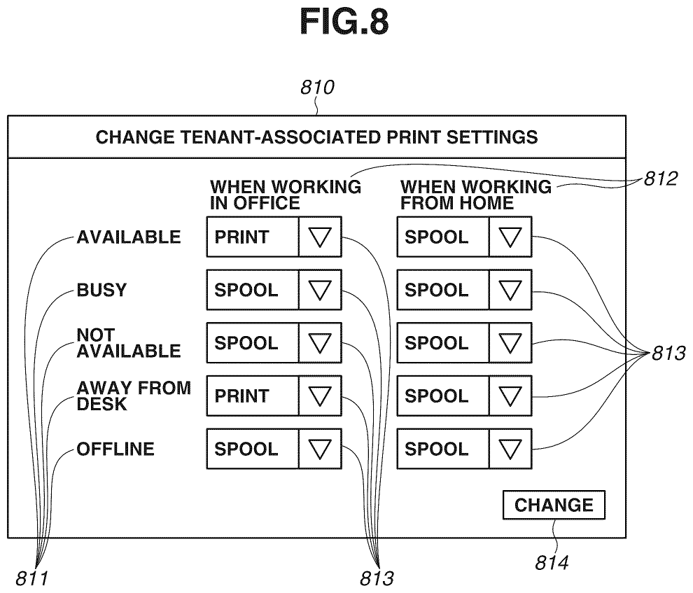

FIG. 8 is a diagram illustrating an example of a status table setting screen 810 for setting the status table 701. The status table setting screen 810 is displayed on the operation unit 116 of the MFP 10.

State items 811 correspond to the “state” column of the status table 701. Work location items 812 correspond to the “work location” column of the status table 701. The user can select operation modes corresponding to the respective statuses by selecting selection fields 813. The options selectable in the selection fields 813 represent the operation modes that the MFP 10 can perform. If an image processing apparatus according to the present exemplary embodiment is an apparatus that does not perform recording, operation modes that can be performed by an apparatus that performs recording based on instructions from the image processing apparatus may be included as options. If a change button 814 is selected, the MFP 10 updates the status table 701 stored in the HDD 114 with the set values. Alternatively, the operation modes selected by the user in the selection fields 813 may be registered upon selection without providing the change button 814. The number of status tables 701 to be stored is not limited to one, and a plurality of status tables 701 may be stored. For example, the plurality of status tables 701 can be named like “weekday” and “holiday” for identification. The status table setting screen 810 may include a not-illustrated “new registration” button in addition to the change button 814. In such a case, when the new registration button is selected, the MFP 10 may store a new status table 701 instead of updating the values of the existing table. The storage location of the new status table 701 may the same as or different from that where the exiting status table 701 is stored (for example, the HDD 114). The new status table 701 can be stored in any location to which the CPU 111 of the MFP 10 can refer during the operation of the present exemplary embodiment.

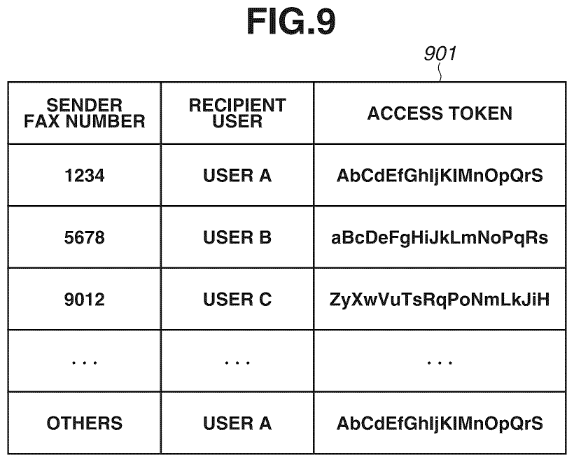

FIG. 9 is a diagram illustrating an example of a recipient user table 901. In the present exemplary embodiment, the recipient user table 901 is, for example, stored in the HDD 114 of the MFP 10.

The recipient user table 901 is a table associating FAX sender information (hereinafter, may be referred to simply as sender information) with the user information 603 about recipient users. In the present exemplary embodiment, sender FAX numbers when FAX documents are received will be described as examples of the sender information. The sender information is not limited to FAX numbers, and may be area codes, Session Initiation Protocol (SIP) addresses, or names, for example. The recipient users are users about whom the MFP 10 requests the status information 609 of the tenant server 40. A sender FAX number refers to the FAX number of an MFP or FAX machine that is different from the MFP 10 and faxes various types of information including image data to the MFP 10. The user information 603 refers to the foregoing information managed by the tenant server 40. In other words, the recipient user table 901 is a table to which the MFP 10 refers for the user information 603 corresponding to the sender information based on the sender information when receiving a FAX document. The recipient user table 901 also stores access token information corresponding to the user information 603. Instead of the access token information, which typically has an expiration date, the recipient user table 901 may store authentication-related information such as user IDs, mail addresses, phone numbers, passwords, and passcodes.

Users who receive FAX documents from senders with unregistered FAX numbers may be set in the recipient user table 901. In the present exemplary embodiment, the recipient user table 901 represents an example where “others” is registered in the sender FAX number as an example of receiving FAX documents from unregistered numbers. The user may register “all” (not illustrated) or a blank as the sender FAX number so that the status information 609 about the same user is acquired in response to image data received from any FAX number. In such a case, the CPU 111 of the MFP 10 receiving a FAX document can skip the process of referring to the sender information and the recipient user table 901 in the processing to be described below.

The user may specify and register only the area code of the sender FAX number, i.e., the first one to three digits of the FAX number in the recipient user table 901 to register recipient users corresponding to the geographic area where the FAX sender is located.

The recipient user table 901 may be stored in the MFP 10 (for example, in the HDD 114) or in an external device that can communicate with the MFP 10. In the present exemplary embodiment, the MFP 10 is configured to acquire the sender information via various communication units. However, the MFP 10 may acquire the sender information by accepting the user's input via the operation unit 116, for example, and register or update the recipient user table 901.

The information for identifying senders (sender information) is not limited to FAX numbers. For example, if the MFP 10 receives various types of information including image data via the network 70, the IP addresses or MAC addresses of the sender user terminals 20 may be acquired and registered in the recipient user table 901 for sender identification.

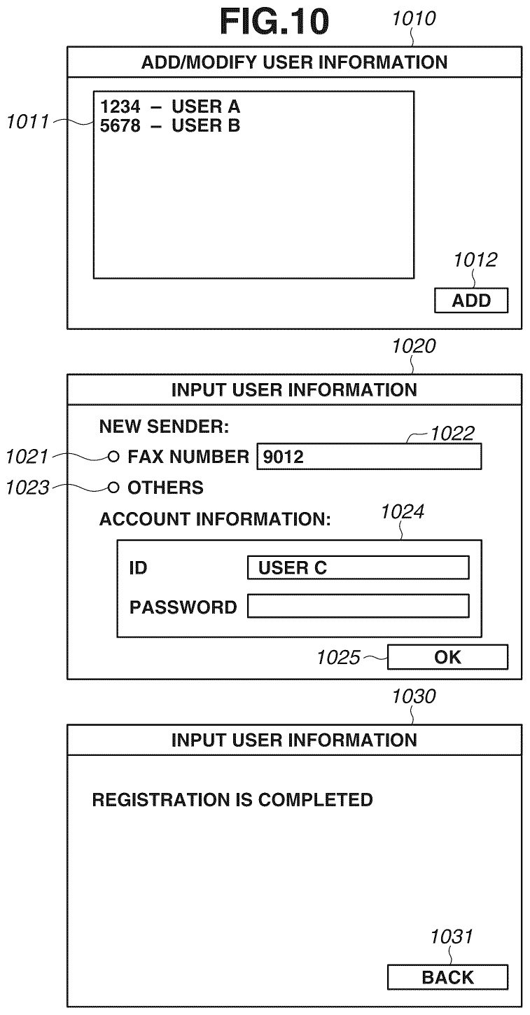

FIG. 10 is a diagram illustrating an example of screens for setting the recipient user table 901. FIG. 10 illustrates a user information add/modify screen 1010 for registering a new item in the recipient user table 901, a user information input screen 1020, and a user information registration completion screen 1030. The group of screens is displayed on the operation unit 116 of the MFP 10.

When a not-illustrated menu screen displayed on the operation unit 116 of the MFP 10 transitions to a recipient user table setting screen via user operation, the user information add/modify screen 1010 is displayed on the operation unit 116 of the MFP 10.

The user information add/modify screen 1010 is a screen that displays information currently registered in the recipient user table 901. An area 1011 is an area that displays the information about the current recipient user table 901. A button 1012 is an add button. When this button 1012 is selected, the user information add/modify screen 1010 displayed on the operation unit 116 of the MFP 10 transitions to the user information input screen 1020.

The user information add/modify screen 1010 may include, for example, a not-illustrated modify button for modifying the information registered in the recipient user table 901, and/or a not-illustrated delete button for deleting information registered in the recipient user table 901.

The user information input screen 1020 is a screen for adding information to the recipient user table 901. The user can select selection items 1021 or 1023.

An input item 1022 is an item that inputs a FAX number. If the selection item 1021 is selected, the user can input FAX sender information to be registered into the input item 1022.

If the selection item 1023 is selected, the user can register user information 603 about the user who receives FAX documents from senders not registered in the recipient user table 901. More specifically, when the selection item 1023 is selected, “others” is input to the recipient user table 901.

An input item 1024 is an item for inputting authentication information intended for authentication of the user information 603. The authentication information is not limited to an ID and a password, and any authentication-related information can be used. Examples include a mail address, a phone number, and a passcode. A button 1025 is a confirmation button. When this button 1025 is selected, the currently input content is added to the recipient user table 901. When the button 1025 is selected, the user information input screen 1020 displayed on the operation unit 116 of the MFP 10 transitions to the user information registration completion screen 1030.

The inputs to the input items 1022 and 1024 are made from the operation unit 116 of the MFP 10. For example, physical buttons on the operation unit 116, such as a keyboard and a numerical keypad, may be operated. A not-illustrated software keyboard may be displayed on the screen of the MFP 10 and operated. The CPU 111 of the MFP 10 may detect the selection of the input item 1021 and automatically display the not-illustrated software keyboard so that the user can input the FAX number into the input item 1022 without selecting the input item 1022.

The screens may be configured so that the user can also specify the storage location of various types of information including image data received by the MFP 10 during the “spool” operation mode. For example, the user information input screen 1020 may display a not-illustrated storage location selection button to have the user select the storage location from one or more options such as the HDD 114 and the cloud storage. For example, the user information input screen 1020 may further display not-illustrated buttons, input fields, and/or selection fields to set a condition for temporarily spooling image data, such as a spooling time, so that the spooled data can be moved or deleted when the condition is met.

The user information registration completion screen 1030 is a screen for notifying the user that the addition of the information to the recipient user table 901 is completed. When the user selects a back button 1031, the user information registration completion screen 1030 transitions to the user information add/modify screen 1010. Alternatively, the user information registration completion screen 1030 may transition to a screen displayed before the user information add/modify screen 1010, such as a home screen. The user information registration completion screen 1030 may further display a not-illustrated “add more” button, or “yes” and “no” buttons along with a message “add more?”, for example, and if the user presses the “add more” button or “yes” button, more entries may be registered. In such a case, the screen may transition to the user information input screen 1020 again.

The user information add/modify screen 1010 may include, for example, a not-illustrated modify button for modifying the information registered in the recipient user table 901. For example, the user selects one of the users displayed in the area 1011 and selects the modify button, or selects the modify button and then selects one of the users displayed. The CPU 111 of the MFP 10 detects the selection of the modify button and the selection of the user, causes a screen transition to the user information input screen 1020, and displays the sender information registered for the selected user in the input item 1022. The user information input screen 1020 may be configured to further include a not-illustrated confirmation button, so that when the confirmation button is selected, the recipient user table 901 is modified with the data input at that timing as the information about the selected user.

The user information add/modify screen 1010 may include, for example, a not-illustrated delete button for deleting information registered in the recipient data table 901. For example, the user selects one of the users displayed in the area 1011 and selects the delete button, or selects the delete button and then selects one of the users displayed. The CPU 111 of the MFP 10 detects the selection of the delete button and the selection of the user, and deletes the stored information corresponding to the selected user from the recipient user table 901. Before the deletion of the information, the user information add/modify screen 1010 may display a not-illustrated “execute delete” button, or “yes” and “no” buttons along with a message “delete?”, for example, and if the user selects the “execute delete” button or the “yes” button, the information may be deleted.

As will be described below, the authentication information input in the input item 1024 when the button 1025 is selected is transmitted to the tenant server 40. If the authentication fails due to unregistered items or the user's input errors, a notification thereof may be displayed on the operation unit 116 of the MFP 10.

The CPU 111, in displaying the notification, may display the user information input screen 1020 on the operation unit 116 again, display the input information again, or display some or all of the items blank.

As will be described below, the user information input screen 1020 may be configured so the account information about the individual user and the channel to which the user belongs can also be input or the channel information 604 can be input, and the CPU 111 may accept such inputs.

The recipient user table 901 may be registered by performing the following not-illustrated processing. The user initially logs into the user account of the message application service by inputting authentication information intended for authentication of the user information 603. Alternatively, based on the user's login to the MFP 10, the CPU 111 logs into the user account corresponding to the information about the user logged in to the MFP 10. Next, the CPU 111 of the MFP 10 communicates with the tenant server 40 to acquire information managed by the tenant server 40, such as the group information 602, the user information 603, the channel information 604, and the list 605 related to the login user account. The CPU 111 finally displays the acquired information on the operation unit 116, and the user selects the user information 603 and the channel information 604 from the displayed information, whereby the information is registered in the recipient user table 901.

When the channel information 604 is registered in the recipient user table 901, the CPU 111 may check the states of all the users in the list 605 where the user information belonging to the channel is summarized. The CPU 111 here may execute printing if any one of the users is in a state corresponding to the print mode. In such a configuration, the user registers the authentication information about some or all of the users belonging to the target channel in the recipient user table 901.

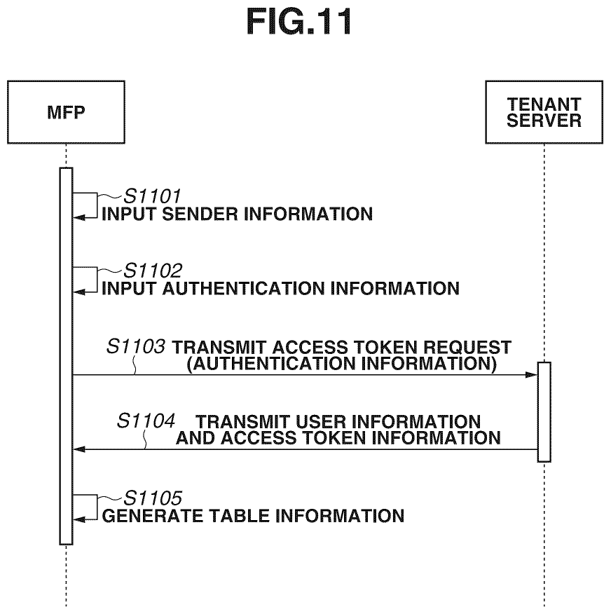

FIG. 11 is a diagram illustrating an example of a sequence for setting the recipient user table 901. This sequence is started when information is added to the recipient user table 901, i.e., at timing when the user information input screen 1020 is displayed on the operation unit 116 of the MFP 10. In this sequence, the processing performed by the MFP 10 and the tenant server 40 will be described.

### Step S1101: Input Sender Information

In step S1101, the CPU 111 of the MFP 10 accepts input of FAX sender information via the operation unit 116. Specifically, the user selects the selection item 1021 and inputs the sender information into the input item 1021, or selects the selection item 1023, and the CPU 111 accepts the sender information.

### Step S1102: Input Authentication Information

In step S1102, the CPU 111 accepts input of authentication information via the operation unit 116. Specifically, the user inputs the authentication information into the input item 1024, and the CPU 111 accepts the authentication information.

### Step S1103: Transmit Request

In step S1103, the CPU 111 transmits an access token request to the tenant server 40. Step S1103 is performed when the button 1025 is selected. When transmitting the access token request, the CPU 111 transmits the authentication information accepted in step S1102 to the tenant server 40.

### Step S1104: Receive Answer

In step S1104, the CPU 401 of the tenant server 40 performs authentication processing using the authentication information received from the MFP 10. If the authentication is successful, the CPU 401 transmits the authenticated user information 603 and the access token information to the MFP 10. The CPU 111 of the MFP 10 receives these pieces of information. That the authentication is successful refers to a case where the authentication information received from the MFP 10 matches authentication information registered in the HDD 405 of the tenant server 40. If the authentication fails, the CPU 401 transmits a notification of the failed authentication to the MFP 10. That the authentication fails refers to a case where the authentication information received from the MFP 10 does not match any of the pieces of authentication information registered in the HDD 405 of the tenant server 40. If the authentication fails, the CPU 401 does not necessarily notify the MFP 10 of the failure, and may discontinue or abort the processing at that point in time. In such a case, the sequence may be configured so that the CPU 111 of the MFP 10 discontinues the processing when the user information and the access token information are not transmitted from the CPU 401 of the tenant server 40 within a predetermined time.

### Step S1105: Generate Table Information

In step S1105, the CPU 111 associates the sender information acquired in step S1101 with the access token information acquired in step S1104, and adds the information to the recipient user table 901.

Once the generation of the table information is completed, the processing ends.

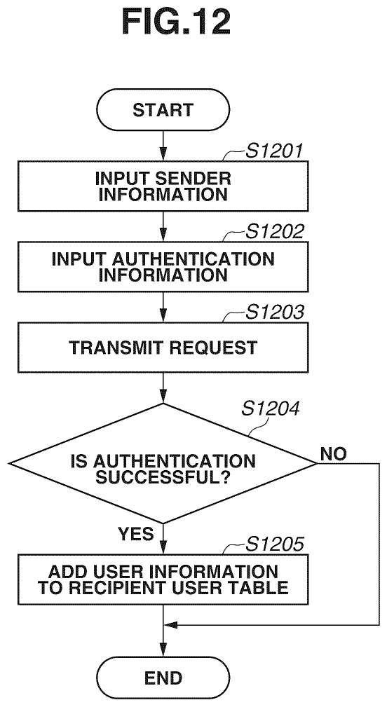

FIG. 12 is a flowchart illustrating an example of setting processing of the recipient user table 901.

This processing is started when information is added to the recipient user table 901, i.e., when the user information input screen 1020 is displayed on the operation unit 116 of the MFP 10. The processing proceeds as appropriate based on the operations of the user and responses from the tenant server 40. The steps of the flowcharts according to the present exemplary embodiment are performed by the CPU 111 of the MFP 10 reading control programs stored in the ROM 112 or the HDD 114 into the RAM 113 and executing the control programs.

### Step S1201: Input Sender Information

In step S1201, the CPU 111 accepts input of FAX sender information via the operation unit 116. Specifically, the user selects the selection item 1021 and inputs the sender information into the input item 1022, or selects the selection item 1023, and the CPU 111 accepts the sender information. The accepted sender information is temporarily stored in the RAM 113. Once the input of the sender information is completed, the processing proceeds to step S1202.

### Step S1202: Input Authentication Information

In step S1202, the CPU 111 accepts input of authentication information via the operation unit 116. Specifically, the user inputs the authentication information into the input item 1024, and the CPU 111 accepts the authentication information. The accepted authentication information is temporarily stored in the RAM 113. Once the input of the authentication information is completed and the button 1025 is selected by the user, the processing proceeds to step S1203.

### Step S1203: Transmit Request

In step S1203, the CPU 111 transmits an access token request to the tenant server 40. When transmitting the access token request, the CPU 111 also transits the sender information and the authentication information that are accepted in steps S1201 and S1202 and temporarily stored in the RAM 113 to the tenant server 40. Once the transmission of the request is completed, the processing proceeds to step S1204.

### Step S1204: Authentication Determination

In step S1204, the CPU 111 waits for a response from the tenant server 40. An example of the response to be transmitted from the tenant server 40 is a notification indicating whether the authentication succeeds or fails. If the authentication is successful, the response also includes the user information and the access token information. The CPU 111 detects the reception of the response from the tenant server 40. If the authentication is determined to be successful from the received response (YES in step S1204), the CPU 111 temporarily stores the user information and the access token information received from the tenant server 40 into the RAM 113, and the processing proceeds to step S1205. If the authentication is determined to be unsuccessful from the response received from the tenant server 40 (NO in step S1204), the CPU 111 determines that the registration in the recipient user table 901 fails, and the processing ends.

### Step S1205: Add User Information

In step S1205, the CPU 111 associates the sender information, the user information, and the access token information temporarily stored in the RAM 113, and adds the pieces of information to the recipient user table 901.

Once the addition of the user information is completed, the processing ends. After the end of the processing of step S1205, the CPU 111 deletes the sender information temporarily recorded in step S1201 from the RAM 113.

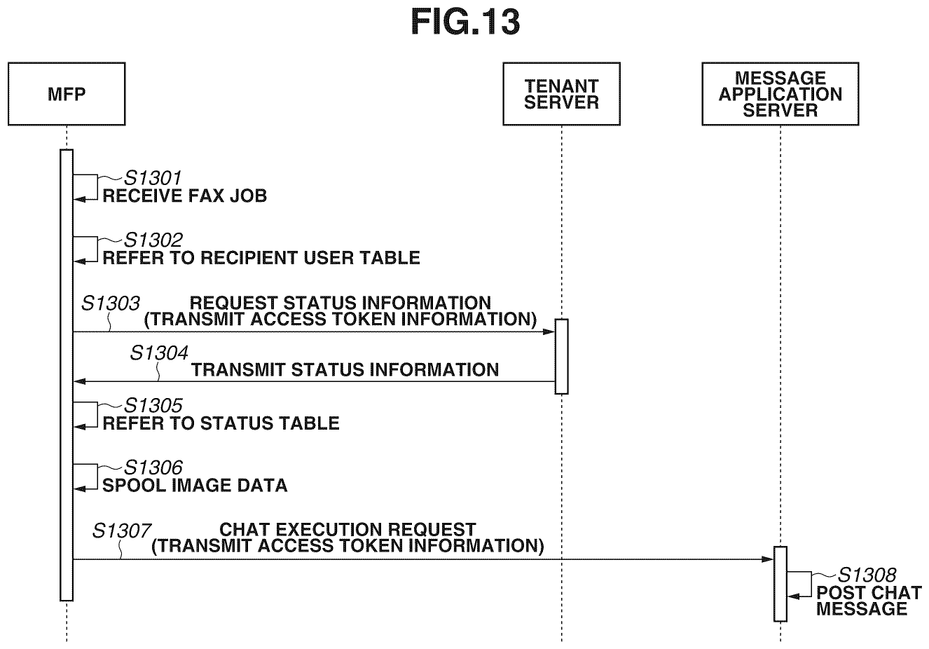

FIG. 13 is a diagram illustrating an example of a sequence when a FAX job is spooled based on the status table 701. This sequence is started by an MFP 10 receiving a FAX job via its FAX communication unit 124. A FAX job refers to a job for performing a series of processes up to the recording of image data received via FAX on recording media, in addition to FAX reception processing. In this sequence, processing performed by the MFP 10, the tenant server 40, and the message application server 30 will be described. The recipient user table 901 according to the present exemplary embodiment stores sender FAX numbers, recipient users, and access token information in association with each other.

### Step S1301: Receive FAX Job

In step S1301, the CPU 111 of the MFP 10 performs analysis processing on FAX job information received via the FAX communication unit 124, and stores the FAX sender information in the RAM 113.

### Step S1302: Refer to Recipient User Table

In step S1302, based on the FAX sender information stored in the RAM 113 in step S1301, the CPU 111 searches the recipient user table 901 stored in the HDD 114 for the access token information about the recipient user corresponding to the sender information, and acquires the access token information.

### Step S1303: Request Status Information

In step S1303, the CPU 111 transmits the access token information corresponding to the sender information acquired in step S1302 to the tenant server 40, and requests the status information 609 about the recipient user corresponding to the access token information.

### Step S1304: Receive Status Information

In step S1304, the CPU 401 of the tenant server 40 acquires the status information 609 about the user requested by the MFP 10 from the tenant information 601 stored in the HDD 405, based on the access token information transmitted from the MFP 10. If the status information 609 about the user requested by the MFP 10 is successfully acquired, the CPU 401 transmits the status information 609 about the user requested by the MFP 10 to the MFP 10. The CPU 111 of the MFP 10 receives the status information 609.

### Step S1305: Refer to Status Table

In step S1305, the CPU 111 acquires operation mode information (operation mode) corresponding to the status information 609 received in step S1304, based on the status table 701 stored in the HDD 114. The CPU 111 stores the status information 609 transmitted from the tenant server 40 in step S1304 into the HDD 114. In step S1402, described below, the status information 609 stored here will be referred to. The following sequence proceeds on the assumption that the acquired operation mode is “spool”.

### Step S1306: Spool Image Data

In step S1306, to move the received FAX job information to a nonvolatile area, the CPU 111 moves the FAX job information from the RAM 113 to the HDD 114. Such a control will be called spool control. The spool control refers to processing (storage processing) for, when the MFP 10 receives information including image data, storing the received information including the image data into the RAM 113 of the MFP 10 or a nonvolatile area such as the HDD 114 without immediately printing the image data. Images based on the image data spooled by the MFP 10 are printed in response to the user's print instructions. The moving destination is not limited to the HDD 114 of the MFP 10, and may be an external nonvolatile area (storage) such as a cloud storage and a flash memory. With the image data received via FAX stored into the nonvolatile area by the spool control, the FAX job information can be retained without being lost even if the subsequent processing is interrupted due to events such as a power outage and a power-off of the MFP 10. If, for example, the FAX job information is stored in the cloud storage, users with access permissions can browse the FAX job information through the cloud service. This enables ubiquitous access for improved convenience.

### Step S1307: Chat Execution Request

In step S1307, the CPU 111 generates a chat execution request for the recipient user corresponding to the received FAX sender information, based on the access token information acquired in step S1302. Next, the CPU 111 transmits this chat execution request to the message application server 30 (transmission instruction). The chat message the CPU 111 requests to post here is “the MFP 10 has received a FAX document, and the image data is spooled”.

### Step S1308: Post Chat Message

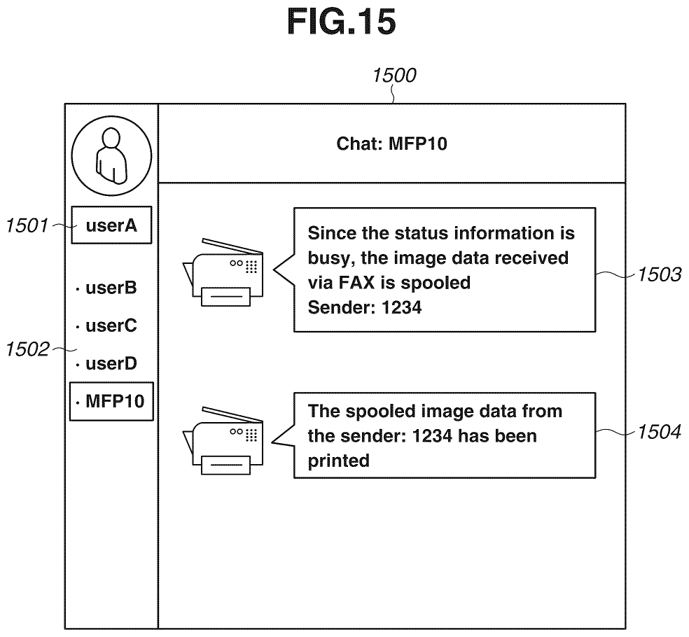

In step S1308, the CPU 301 of the message application server 30 transmits a notification that the chat execution request is issued in step S1307 to the user terminal 20 along with the chat message. The notification and the chat message may be actively transmitted by the CPU 301 of the message application server 30, or passively transmitted, for example, based on a timeline acquisition request from the user terminal 20. The message application 306 installed on the HDD 210 of the user terminal 20 displays the chat message (chat message 1503; see FIG. 15) received from the message application server 30 on the operation panel 201 of the user terminal 20 to notify the recipient user.

The chat message notified in step S1308 may include part of the FAX job information. For example, the chat message 1503 includes the FAX sender information. When issuing the chat execution request in step S1307, the MFP 10 also transmits the FAX job information, whereby the message application server 30 can acquire the FAX job information.

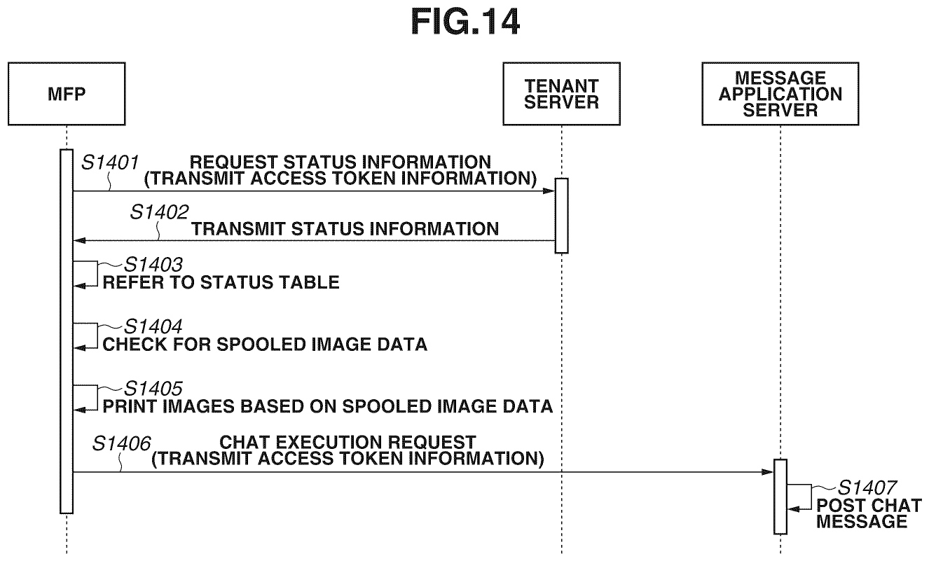

FIG. 14 is a diagram illustrating an example of a sequence when images based on spooled image data are printed based on a change in status. This sequence represents processing that takes place when, in or after step S1307, the CPU 111 detects a change in the status information 609 about the same user and the operation mode corresponding to the changed status information 609 is found to be “print” based on the status table 701. The status may be manually input and updated via the message application 306 by the user operating the user terminal 20, or automatically estimated and updated based on information such as an update history of the tenant information 601 and an operation history of the user terminal 20. This processing is performed without the user's print instructions. In this sequence, processing performed by the MFP 10, the tenant server 40, and the message application server 30 will be described.

### Step S1401: Request Status Information

In step S1401, the CPU 111 of the MFP 10 transmits the access token information acquired from the recipient user table 901 in step S1302 to the tenant server 40, and requests status information. What is requested in step S1401 is the status information 609 about the recipient user corresponding to the sender information about the image data spooled in step S1306. The CPU 111 may request the status information 609 about all the users stored in the tenant server 40.

### Step S1402: Receive Status Information

In step S1402, the CPU 401 of the tenant server 40 acquires the status information 609 about the user requested by the MFP 10 from the tenant information 601 stored in the HDD 405 based on the access token information transmitted from the MFP 10. If the status information 609 about the user requested by the MFP 10 is successfully acquired, the CPU 401 transmits the status information 609 about the user requested by the MFP 10 to the MFP 10. The CPU 111 of the MFP 10 receives the status information 609. If the status information 609 transmitted from the tenant server 40 is different from the status information 609 received in step S1304, the CPU 111 of the MFP 10 determines that a change is detected, and performs the processing of step S1403.

### Step S1403: Refer to Status Table

In step S1403, the CPU 111 acquires the operation mode information corresponding to the status information 609 acquired in step S1402, based on the status table 701 stored in the HDD 114. The following sequence proceeds on the assumption that the mode indicated by the acquired operation mode information is “print”.

### Step S1404: Check for Spooled Image Data

In step S1404, the CPU 111 searches for image data that is received by the MFP 10 and spooled in the HDD 114 by the spool control of step S1306. While the spool control is performed in step S1306, there can be no spooled image data in step S1404 if, for example, the user operates the operation unit 116 of the MFP 10 and prints the spooled image data before the status information 609 is updated.

### Step S1405: Print Images Based on Spooled Image Data

In step S1405, the CPU 111 prints images based on the image data received and spooled by the MFP 10, searched for in step S1404. More specifically, the printing unit 120 of the MFP 10 records the images based on the image data received based on the FAX job received by the MFP 10 in step S1301 on recording media. Printing on recording sheets is an example thereof. If, in step S1306, the image data received by the MFP 10 is spooled not in the HDD 114 but in a cloud storage, for example, the MFP 10 acquires the image data from the spooling cloud storage and prints the image data. Step S1405 is performed without the user's print instructions. The MFP 10 may perform the print processing for printing the images based on the image data received by the MFP 10 via FAX in response to the user's print instructions.

### Step S1406: Chat Execution Request

In step S1406, the CPU 111 generates a chat execution request for the recipient user corresponding to the sender information about the received FAX job, based on the access token information acquired from the recipient user table 901 in step S1302. Next, the CPU 111 transmits the chat execution request to the message application server 30 (transmission instruction). The chat message the CPU 111 requests to post here is “the MFP has received a FAX document, and the printing of the images based on the spooled FAX-received image data is completed”.

### Step S1407: Post Chat Message

In step S1407, the CPU 301 of the message application server 30 transmits a notification that the chat execution request is issued from the MFP 10 in step S1406 to the user terminal 20.

The notification may be actively transmitted by the CPU 301 of the message application server 30, or passively transmitted, for example, based on a timeline acquisition request from the user terminal 20. The message application 306 installed on the HDD 210 of the user terminal 20 displays the chat message (chat message 1504) received from the message application server 30 on the operation panel 201 of the user terminal 20 to notify the recipient user.

Once the issuance of the chat message request in step S1406 is completed, the CPU 111 ends the processing.

The notification to the recipient user in steps S1405 and S1406 is not essential, and the MFP 10 does not necessarily need to issue the notification that the spooled image data is printed.

The status information 609 requested in step S1401 may be the information about the status of the user corresponding to the sender information about image data remaining in the HDD 114, instead of the status of the user corresponding to the sender information about the image data spool-controlled in step S1306. In such a case, for example, the processing of step S1404 and step S1608, described below, can be omitted since there will be no processing for jobs that have been cleared by the user operating the operation unit 116 of the MFP 10 to print the spooled image data before the status information 609 is updated.

FIG. 15 is a diagram illustrating an example of a chat screen 1500 of the message application 306. The chat screen 1500 is a screen provided by the message application 306 and a chat screen displayed on the operation panel 201 of the user terminal 20.

A display field 1501 displays information about the user. The chat screen 1500 is a screen used by user A. A display field 1502 is a field that displays a list of chat partners with chat history. The chat screen 1500 displays a chat screen with an MFP 10.

The chat message 1503 is the one posted in step S1308, an example of a chat message for notifying the user that the MFP 10 has received a FAX document and the image data is spooled. The chat message 1504 is the one posted in step S1407, an example of a chat message for notifying the user that the spooled image data has been printed.

The types and layout of the pieces of information displayed on the chat screen 1500 are just an example, and may differ from the example depending on the provider of the message application 306 and the user who customizes the message application 306.

The MFP 10 may be configured to accept the user's print instructions from the chat screen 1500 so that the user can instruct the MFP 10 to print images based on the spooled image data via the chat screen 1500. With such a configuration, when the MFP 10 spools the image data received by the MFP 10, the recipient user corresponding to the sender information can transmit print instructions to the MFP 10 performing the spool processing via the chat screen 1500. Receiving the print instructions, the MFP 10 prints the images based on the image data spooled in the HDD 114 using the printing unit 120, for example.

If a plurality of MFPs 10 is connected and can communicate spooled image data with each other, the user may transmit the print instructions to any one of the MFPs 10, such as the one closest to the user's current location.

The user's print instructions from the chat screen 1500 may be issued using a software button displayed by the message application 306 or a physical button on the user terminal 20. The print instructions may be given by the user replying with a sentence such as “print it” in the chat. The user terminal 20 may include a gyro sensor, for example, and may be configured to transmit the print instructions to the MFP 10 in response to the user's specific action, such as a shake, after the display of the chat message 1503.

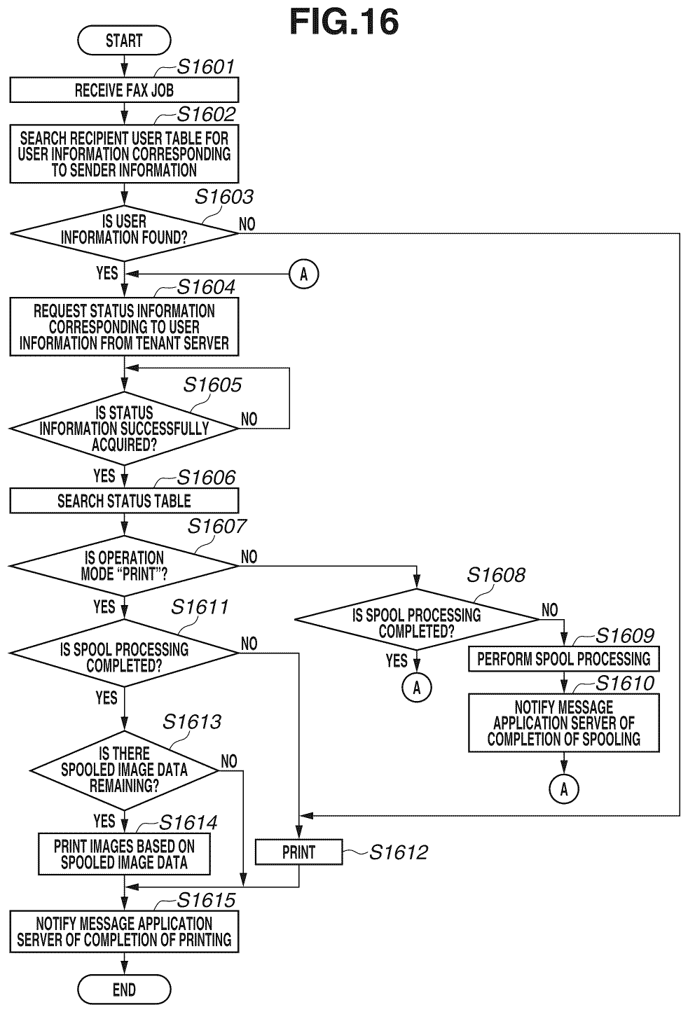

FIG. 16 is a flowchart illustrating an example of processing of a FAX job received by an MFP 10. Specifically, FIG. 16 illustrates processing where the MFP 10 spools or prints the received image data based on the acquired status information 609 about the user and the status table 701. This processing is started by the MFP 10 receiving the FAX job via the FAX communication unit 124.

### Step S1601: Receive FAX Job

In step S1601, the CPU 111 of the MFP 10 temporarily stores the received FAX job information in the RAM 113. Once the reception of the FAX job is completed, the processing proceeds to step S1602.

### Step S1602: Search for User Information

In step S1602, the CPU 111 of the MFP 10 searches the recipient user table 901 stored in the HDD 114 for the user information 603 corresponding to the sender information based on the sender information about the FAX job information stored in the RAM 113 in step S1601. Once the search for the user information 603 is completed, the processing proceeds to step S1603.

### Step S1603: Determination as to Finding of User Information

In step S1603, the CPU 111 of the MFP 10 determines whether the user information 603 corresponding to the sender information is found in the recipient user table 901 in step S1602. If the CPU 111 determines that the user information 603 corresponding to the sender information is found in the recipient user table 901 (YES in step S1603), the processing proceeds to step S1604. If the CPU 111 determines that the user information 603 corresponding to the sender information is not found in the recipient user table 901 (NO in step S1603), the processing proceeds to step S1612 irrespective of the information in the recipient user table 901.

### Step S1604: Request Status Information

In step S1604, the CPU 111 of the MFP 10 acquires the access token information corresponding to the found user information 603 from the recipient user table 901. The CPU 111 also transmits the access token information to the tenant server 40 and requests the status information 609. Once the request of the status information 609 is completed, the processing proceeds to step S1605.

### Step S1605: Determination as to Acquisition of Status Information

In step S1605, the CPU 111 of the MFP 10 waits until the status information 609 is transmitted from the tenant server 40. If the CPU 111 determines that the status information 609 is transmitted from the tenant server 40 and is successfully acquired (YES in step S1605), the processing proceeds to step S1606. If the CPU 111 determines that the status information 609 is not successfully acquired yet (NO in step S1605), the processing returns to step S1605 and the CPU 111 continues waiting.

### Step S1606: Search Status Table

In step S1606, the CPU 111 of the MFP 10 searches the status table 701 for the operation mode corresponding to the status information 609 based on the status information 609 acquired in step S1605, and acquires the operation mode.

### S1607: Determine Operation Mode

In step S1607, the CPU 111 of the MFP 10 determines whether the operation mode corresponding to the status information 609 acquired in step S1606 is “spool” or “print”. If the CPU 111 determines that the operation mode corresponding to the acquired status information 609 is “spool” (NO in step S1607), the processing proceeds to step S1608. If the CPU 111 determines that the operation mode corresponding to the acquired status information 609 is “print” (YES in step S1607), the processing proceeds to step S1611.

### Step S1608: Determine Whether Spool Processing is Completed

In step S1608, the CPU 111 of the MFP 10 determines whether the spool processing of the FAX job being processed is completed. If the CPU 111 determines that the spool processing of the FAX job being processed is completed (YES in step S1608), the processing proceeds to step S1604. If the CPU 111 determines that the spool processing of the FAX job being processed is not completed (NO in step S1608), the processing proceeds to step S1609.

### Step S1609: Spool Processing

In step S1609, the CPU 111 of the MFP 10 moves the FAX job information stored in the RAM 113 in step S1601 to the HDD 114 to perform the spool processing of the image data. Once the spool processing of the image data is completed, the processing proceeds to step S1610.

### Step S1610: Notify “Completion of Spooling”

In step S1610, the CPU 111 of the MFP 10 notifies the message application server 30 that the image data is spooled by the MFP 10. In other words, in step S1610, the CPU 111 posts the chat message 1503 to the user via the message application server 30 and the message application 306. Once the notification of the “completion of spooling” is completed, the processing proceeds to step S1604. This notification is transmitted to the talk room corresponding to the user about whom the status information 609 is acquired.

### Step S1611: Determine Whether Spool Processing is Completed

In step S1611, the CPU 111 of the MFP 10 determines whether the spool processing of the FAX job being processed is completed. If the CPU 111 determines that the spool processing of the FAX job being processed is not completed (NO in step S1611), the processing proceeds to step S1612. If the CPU 111 determines that the spool processing of the FAX job being processed is completed (YES in step S1611), the processing proceeds to step S1613.

### Step S1612: Print

In step S1612, the CPU 111 of the MFP 10 issues instructions to print images based on the image data stored in the RAM 113 in step S1601, and the printing unit 120 prints the images. Once the printing is completed, the processing proceeds to step S1615.

### Step S1613: Determine Whether There is Spooled Image Data Remaining

In step S1613, the CPU 111 of the MFP 10 determines whether the image data stored by the spool processing in step S1609 remains in the HDD 114. If the CPU 111 determines that the image data stored by the spool processing remains in the HDD 114 (YES in step S1613), the processing proceeds to step S1614. If the CPU 111 determines that the image data stored by the spool processing does not remain in the HDD 114 (NO in step S1613), the processing proceeds to step S1615. Examples of the reason why the image data stored by the spool processing does not remain in the HDD 114 include the user directly operating the operation unit 116 in the MFP 10 to print the images based on the image data and quitting printing.

### Step S1614: Print Images Based on Spooled Image Data

In step S1614, the CPU 111 of the MFP 10 issues instructions to print the images based on the image data stored in the HDD 114 by the spool processing, and the printing unit 120 prints the images. Once the printing of the images based on the spooled image data is completed, the processing proceeds to step S1615. When the images based on the spooled image data are printed by the MFP 10, the CPU 111 deletes the spooled image data. This deletion is not essential, and the spooled image data may continue to be retained even after the images based on the spooled image data are printed by the MFP 10.

### Step S1615: Notify “Completion of Printing”

In step S1615, the CPU 111 of the MFP 10 notifies the message application server 30 of the completion of printing by the MFP 10. In other words, in step S1615, the CPU 111 posts the chat message 1504 to the user via the message application server 30 and the message application 306. This notification is transmitted to the talk room corresponding to the user about whom the status information 609 is acquired. Once the notification of the “completion of printing” is completed, the processing ends. When the processing of step S1615 ends, the CPU 111 deletes the sender information temporarily recorded in step S1601 from the RAM 113.

With the foregoing configuration, the print processing or the spool processing on the job received by the MFP 10 can be performed with reference to the status table 701, the recipient user table 901, and the status information 609 stored in the tenant server 40. The MFP 10 can perform printing by detecting a change in the status information 609 stored in the tenant server 40.

Conventionally, if an MFP performs spool processing of received image data, the spooled image data has been printed in response to user actions, such as operating the MFP to issue print instructions, transmitting print instructions in the chat, and bringing the user terminal close to the MFP.

According to the present exemplary embodiment, if image data is spooled, the image processing apparatus detects a change of the status information 609 into specific status information 609 indicating that the user can immediately receive the printout, and prints the images based on the image data without user operation. The present exemplary embodiment can thus provide the effect of reducing the effort to print the images of the received image data in situations where the user can immediately receive the printout.

In cases where the recipient user is unable to immediately receive the FAX document received by the MFP 10, such as when the recipient user is absent, the FAX document is not immediately printed upon reception. This provides the effect of guaranteeing safety in terms of information security.

In the present exemplary embodiment, as described above, the operation modes of the MFP 10 are associated with the situation statuses and the attendance statuses as the status information 609. However, the status information 609 may include only the situation statuses, and there may be cases where the effects of the present exemplary embodiment can thereby be provided. However, to enhance the effects of the present exemplary embodiment, a plurality of indices of different attributes are desirably used for the status information 609 as in the present exemplary embodiment.

In the present exemplary embodiment, the recipient user table 901 is configured so that the user information 603 is registered therein. However, the channel information 604 may be registered instead of the user information 603. This configuration enables checking the states of all the users in the list 605 where the user information belonging to the channel information 604 is summarized, and can print if any one of the users is in a state corresponding to the print mode. With such a configuration, the users register the authentication information about some or all of the users belonging to the target channel in the recipient user table 901. As described above, the MFP 10 acquires and registers the access token information about each user, and acquires the status information 609 about each user. The users may register the channel information 604 in the recipient user table 901 by inputting channel IDs. In such a configuration, the MFP 10 issues the chat execution request not to individual users, but to a shared channel, such as a group chat.

In this configuration, the MFP 10 may print when one of the users in the list 605 where the user information belonging to the channel information 604 is summarized transmits print instructions to the MFP 10 via the chat screen 1500. In the present exemplary embodiment, the MFP 10 is configured to perform the processing for acquiring the status information 609 in step S1304, with the reception of the FAX job in step S1301 as a trigger. However, the MFP 10 may be configured to periodically acquire the status information 609 and store the status information 609 in the HDD 114 before the reception of the FAX job. The sequence can thereby be continued without accessing the tenant server 40.

If the recipient user of the image data received by the MFP 10 can be identified or the cloud service can be accessed without using authentication information, the access token information does not necessarily need to be handled. For example, if the cloud service manages the users with only the IDs specific to the respective users without an authentication process, the users may register their IDs in the recipient user table 901 instead of the access token information. In such a case, the authentication information-related processing in steps S1102 to S1104, S1201 to S1204, S1303, and S1401 according to the present exemplary embodiment can be omitted.

If there are situations where a user is likely to be able to immediately receive the printout and situations where they are not, the effort for the image processing apparatus to print images based on image data received via FAX can be reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-017771, filed Feb. 8, 2024, which is hereby incorporated by reference herein in its entirety.

What is claimed is:

1. An image processing apparatus comprising:
a modem configured to receive image data via facsimile (FAX);
one or more memories storing one or more programs and one or more processors executing the program to cause the image processing apparatus to acquire status information indicating a state of a user from a chat service; and
a printer configured to print an image based on the received image data on a recording medium,
wherein the processor causes the image processing apparatus to acquire the status information about a user corresponding to sender information about the received image data, and
wherein the printer is configured to, based on acquisition of specific status information, print the image based on the received image data on the recording medium without the image processing apparatus accepting the user's print instruction after the acquisition of the status information.

2. The image processing apparatus according to claim 1, wherein the image processing apparatus performs different processing depending on the acquired status information.

3. The image processing apparatus according to claim 2, wherein in a case where the acquired status information is the specific status information, print processing for printing the image based on the received image data on the recording medium is performed, and in a case where the acquired status information is not the specific status information, storage processing for storing the received image data in a storage device is performed.

4. The image processing apparatus according to claim 3, wherein the print processing is not performed until the acquisition of the specific status information.

5. The image processing apparatus according to claim 4, wherein the received image data is stored in the storage device until the acquisition of the specific status information.

6. The image processing apparatus according to claim 5, wherein the image processing apparatus is configured to accept the user's setting of the specific status information.

7. The image processing apparatus according to claim 1, further comprising a communicator, wherein the communicator is configured to transmit a notification transmission instruction to a chat server via a network.

8. The image processing apparatus according to claim 7, wherein the notification transmission instruction is an instruction to transmit a notification of processing content of the image processing apparatus.

9. The image processing apparatus according to claim 8, wherein the notification is a notification that storage processing for storing the received image data in a storage device is performed, the storage processing being performed in a case where the acquired status information is not the specific status information.

10. The image processing apparatus according to claim 8, wherein the notification is a notification that print processing for printing the image based on the received image data on the recording medium is performed, the print processing being performed in a case where the acquired status information is the specific status information.

11. The image processing apparatus according to claim 8, wherein the notification is transmitted to a talk room corresponding to the user about whom the status information is acquired.

12. The image processing apparatus according to claim 8, wherein the notification is transmitted to a channel to which the user about whom the status information is acquired belongs.

13. The image processing apparatus according to claim 8, wherein the notification is presented in a chat.

14. The image processing apparatus according to claim 1, wherein the image processing apparatus is configured to accept the print instruction from an external apparatus configured to communicate with the image processing apparatus via a network.

15. The image processing apparatus according to claim 1, wherein the processor cause the image processing apparatus to accept the print instruction.

16. The image processing apparatus according to claim 1, wherein the processor causes the image processing apparatus to acquire the status information about the user belonging to a channel associated with the sender information about the received image data.

17. The image processing apparatus according to claim 1, wherein the printer is configured to print the image based on the received image data on the recording medium, the image data received from a cloud storage.

18. An image processing method for an image processing apparatus, the method comprising:
receiving image data via facsimile (FAX);
acquiring status information indicating a state of a user from a chat service; and
printing an image based on the received image data on a recording medium,
wherein the status information about a user corresponding to sender information about the received image data is acquired, and
wherein, based on acquisition of specific status information, the image based on the received image data is printed on the recording medium without the image processing apparatus accepting the user's print instruction after the acquisition of the status information.

19. A non-transitory computer readable storage medium for storing a program causing an image processing apparatus to perform an image processing method, the image processing method comprising:
receiving image data via facsimile (FAX);
acquiring status information indicating a state of a user from a chat service; and
printing an image based on the received image data on a recording medium,
wherein the status information about a user corresponding to sender information about the received image data is acquired, and
wherein, based on acquisition of specific status information, the image based on the received image data is printed on the recording medium without the image processing apparatus accepting the user's print instruction after the acquisition of the status information.
